(19) United States
(12) Patent Application Publication
(10) Pub. No.: US 2025/0128513 A1
(43) Pub. Date: Apr. 24, 2025

(54) LIQUID EJECTION HEAD, LIQUID EJECTION APPARATUS, AND MANUFACTURING METHOD OF LIQUID EJECTION HEAD

(71) Applicant: CANON KABUSHIKI KAISHA, Tokyo (JP)

(72) Inventors: ZENTARO TAMENAGA, Kanagawa (JP); TAKASHI TERAGAKI, Kanagawa (JP); HIROYUKI KIGAMI, Kanagawa (JP)

(21) Appl. No.: 18/923,972

(22) Filed: Oct. 23, 2024

(30) Foreign Application Priority Data
Oct. 24, 2023 (JP) 2023-182414

(51) Int. Cl. B41J 2/14; B41J 2/16

(52) U.S. Cl. CPC B41J 2/14201; B41J 2/1607; B41J 2/1623; B41J 2002/14491; B41J 2202/22

(57) ABSTRACT

An object is to provide a liquid ejection head capable of improving reliability of the connection section between an element substrate and an electrical wiring substrate. The liquid ejection head ejecting liquid includes an element substrate having a terminal and a wiring substrate including a wiring portion connected to the terminal in contact therewith. In a direction perpendicular to a surface on which the terminal is provided on the element substrate, a second distance between the end portion of the element substrate and the wiring portion is greater than a first distance between the surface on which the terminal is provided and a portion opposite to the terminal of the wiring portion.

### BACKGROUND

### Field of the Disclosure

The present disclosure relates to a liquid ejection head, a liquid ejection apparatus, and a manufacturing method of a liquid ejection head, and in detail, relates to a technique to connect a terminal on a substrate and a wiring portion of a wiring substrate.

### Description of the Related Art

As this type of technique, Japanese Patent Laid-Open No. 2021-54066 has described a manufacturing method of a liquid ejection head including a process of directly connecting an electrode terminal of an element substrate and a wiring portion of a wiring substrate (electrical wiring substrate). Specifically, the wiring portion of the electrical wiring substrate is put close to the electrode terminal provided on the element substrate and then after they are abutted or bonded by metallic bonding, the electrode portion is protected by a resin layer, for example, such as a sealing agent. Due to this, the operation accompanying the wire arrangement or the like in a case where connection is performed is not necessary unlike wire bonding, and therefore, the productivity of a liquid ejection head improves.

### SUMMARY

The process of connecting the wiring portion to the terminal of the substrate is performed in the state where the terminal and the wiring portion are opposite to each other. Because of this, for example, in a case where the wiring substrate inclines unintentionally, it may happen sometimes that the area other than the area opposite to the terminal of the wiring portion comes into contact with the element substrate. As a result of that, there is a possibility that trouble is caused, such as an electrical connection failure.

An object of the present disclosure is to provide a liquid ejection head capable of improving reliability of the connection section between an element substrate and an electrical wiring substrate.

The liquid ejection head according to the present disclosure includes: an element substrate having a terminal; and a wiring substrate including a wiring portion connected to the terminal in contact therewith and bonded to a first surface on which the terminal of the element substrate is provided, wherein on the element substrate, a plurality of the terminals forms a terminal array arranged along an end portion of the element substrate and in a direction perpendicular to the first surface on the element substrate, a second distance between the end portion of the element substrate and the wiring portion is greater than a first distance between the first surface and a portion opposite to the terminal of the wiring portion.

Further features of the present disclosure will become apparent from the following description of exemplary embodiments with reference to the attached drawings.

### BRIEF DESCRIPTION OF THE DRAWINGS

FIG. 1 is a diagram showing a configuration of a liquid ejection apparatus according to one embodiment;

FIG. 2 is a perspective diagram showing one of head portions according to one embodiment;

FIG. 3 is a perspective diagram showing a configuration of a liquid ejection unit according to one embodiment;

FIG. 4 is an exploded perspective diagram of a liquid ejection unit according to one embodiment;

FIG. 5 is a diagram for explaining a configuration for connection according to one embodiment;

FIG. 6 is a cross-sectional diagram schematically showing a liquid ejection unit according to one embodiment;

FIG. 7 is a diagram explaining a positional relationship between an element substrate and an electrical wiring substrate according to one embodiment;

FIG. 8 is a flowchart showing a manufacturing process of a liquid ejection apparatus according to one embodiment;

FIG. 9A is an explanatory diagram of a process of putting an electrical wiring substrate close to an element substrate 301;

FIG. 9B is an explanatory diagram of a process of connecting an electrical wiring substrate to the element substrate 301;

FIG. 10A is a diagram showing a state where an electrical wiring substrate is connected to an element substrate correctly in a comparative example;

FIG. 10B is a diagram showing a state where an electrical wiring substrate is not connected to an element substrate correctly in a comparative example;

FIG. 11A is a schematic cross-sectional diagram showing the way a process of connecting an electrical wiring substrate to an element substrate is in the present embodiment;

FIG. 11B is a schematic cross-sectional diagram for explaining a concave portion in the present embodiment;

FIG. 11C is a schematic cross-sectional diagram of a second liquid ejection unit in the present embodiment;

FIG. 12A is a schematic cross-sectional diagram showing the way a process of connecting an electrical connection section to an electrical terminal is in the present embodiment;

FIG. 12B is a schematic cross-sectional diagram for explaining a step in the present embodiment; and

FIG. 12C is a schematic cross-sectional diagram of a third liquid ejection unit in the present embodiment.

### DESCRIPTION OF THE EMBODIMENTS

### First Embodiment

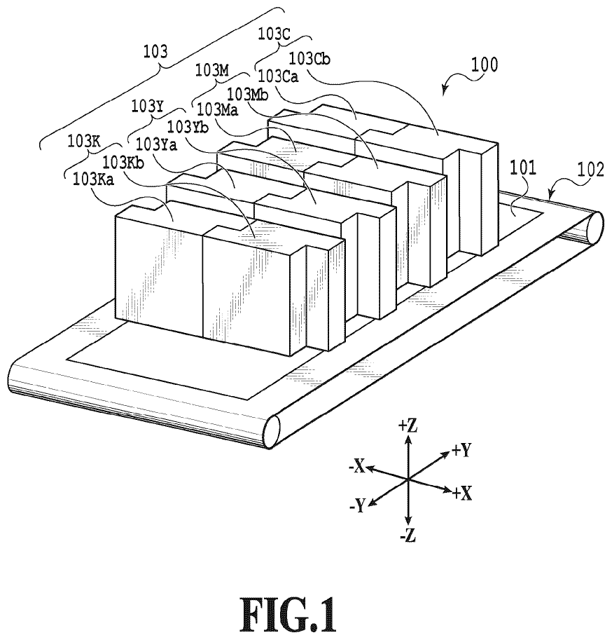

FIG. 1 is a diagram showing the configuration of a liquid ejection apparatus 100 according to one embodiment of the present disclosure.

First, the coordinate system shown in the drawings referred to in the present specification is explained. As shown in in FIG. 1, the −Y-direction is the direction in which a printing medium 101 is conveyed and the −Y-direction is toward the upstream side in the conveyance direction. The X-direction is the longitudinal direction (width direction) of a liquid ejection head 103 and in this case, the transverse direction (depth direction) of the liquid ejection head 103 is the direction along the Y-direction. The Z-direction is the height direction of the liquid ejection head 103.

As shown in FIG. 1, the liquid ejection apparatus 100 comprises a conveyance unit 102 configured to convey the printing medium 101 in the conveyance direction and the liquid ejection head 103 ejecting liquid to the printing medium 101.

In the present embodiment, a cut sheet is used as the printing medium 101. The conveyance unit 102 has a conveyance belt, a conveyance roller pivotally moving the conveyance belt, and the like. In detail, the conveyance unit 102 performs conveyance by adsorbing and holding the printing medium 101 to the conveyance belt by a suction mechanism, not shown schematically, and pivotally moving the conveyance belt. The printing medium 101 for which printing has been performed by the liquid ejection head is peeled off from the conveyance belt by a mechanism, not shown schematically, on the downstream side and discharged to a paper discharge unit (not shown schematically). The liquid ejection head 103 is the so-called page-wide type liquid ejection head in which ejection ports are arrayed in accordance with the width (length in the X-direction) of the printing medium 101.

The liquid ejection head 103 includes liquid ejection heads 103C, 103M, 103Y, and 103K ejecting liquids (for example, inks) of cyan, magenta, yellow, and black, respectively, in order from the upstream side in the conveyance direction of a printing medium. The liquid ejection head 103C ejecting cyan ink is configured by bonding a head portion 103Ca and a head portion 103Cb. Like the liquid ejection head 103C, the liquid ejection head 103M of magenta ink is configured by bonding a head portion 103Ma and a head portion 103Mb. Like the liquid ejection head 103M, the liquid ejection head 103Y of yellow ink is configured by bonding a head portion 103Ya and a head portion 103Yb. Like the liquid ejection head 103Y, the liquid ejection head 103K of black ink is configured by bonding a head portion 103Ka and a head portion 103Kb. In the following, in a case where it is not necessary to particularly distinguish the head portions 103Ca, 103Cb, 103Ma, 103Mb, 103Ya, 103Yb, 103Ka, and 103Kb from one another, they are simply called the head portion.

Each of the liquid ejection heads 103C, 103M, 103Y, and 103K has the same configuration. The ink of each color described above is ejected by the ink of a color corresponding to each of the liquid ejection heads 103C, 103M, 103Y, and 103K being supplied. In the following, in a case where it is not necessary to particularly distinguish the liquid ejection heads 103C, 103M, 103Y, and 103K from one another, they are simply called the liquid ejection head 103. In the present embodiment, it is possible for the liquid ejection head 103 to perform full-color printing for the printing medium 101 that is conveyed by ejecting inks of cyan, magenta, yellow, and black.

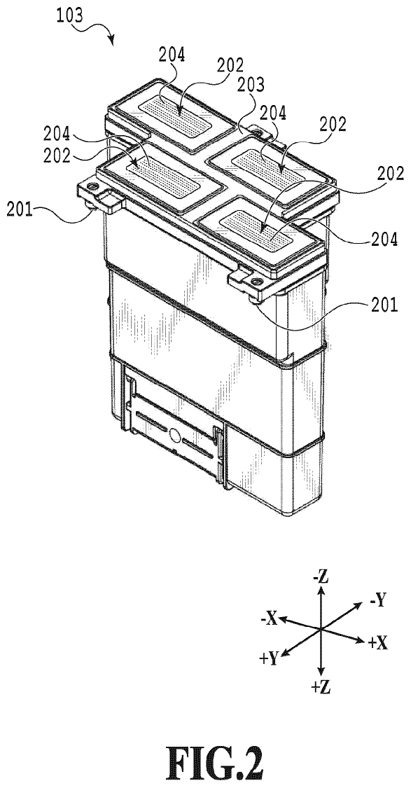

FIG. 2 is a perspective diagram showing one of the head portions in the liquid ejection head 103 according to the present embodiment, which is explained in FIG. 1.

As shown in FIG. 2, the head portion of the liquid ejection head 103 comprises a liquid ejection unit 202 including a mechanism configured to eject liquid and a common support member 203 configured to supply a plurality of the liquid ejection units 202. Further, the head portion of the liquid ejection head 103 comprises a reference member 201 having a function of determining the position with respect to the liquid ejection apparatus 100. By this reference member 201 engaging with an engagement portion (not shown schematically) of the liquid ejection apparatus 100, the position of the liquid ejection head 103 is determined with respect to the liquid ejection apparatus 100.

In the present embodiment, the four liquid ejection units 202 are arranged in a staggered pattern on the common support member 203. In each of the liquid ejection units 202, about 1,000 ejection ports 204 are formed and it is possible for the liquid ejection unit 202 to perform printing with 1,200 dpi by ejecting liquid from the ejection port 204.

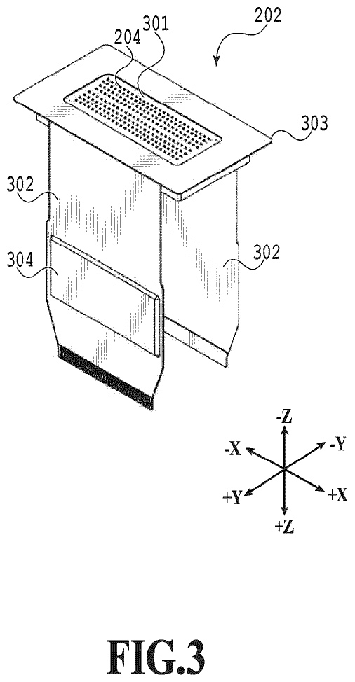

FIG. 3 is a perspective diagram showing a detailed configuration of the liquid ejection unit 202 shown in FIG. 2.

As shown in FIG. 3, the liquid ejection unit 202 comprises the element substrate 301 including ejection ports ejecting liquid, liquid channels communicating with the ejection ports, energy generation elements and the like, and an electrical wiring substrate 302 electrically connected to the element substrate 301. As one example of the electrical wiring substrate 302, there are FPC (Flexible Printed Circuits), TAB (Tape Automated Bonding) and the like.

The liquid ejection unit 202 comprises a support member 303 for reinforcing the element substrate 301. The support member 303 is bonded to the ejection surface side of the element substrate 301. The electrical wiring substrate 302 is provided with a drive circuit substrate 304 for driving an energy generation element (not shown schematically) generating energy for ejecting liquid. In the present embodiment, as the energy generation element, a piezoelectric element is used.

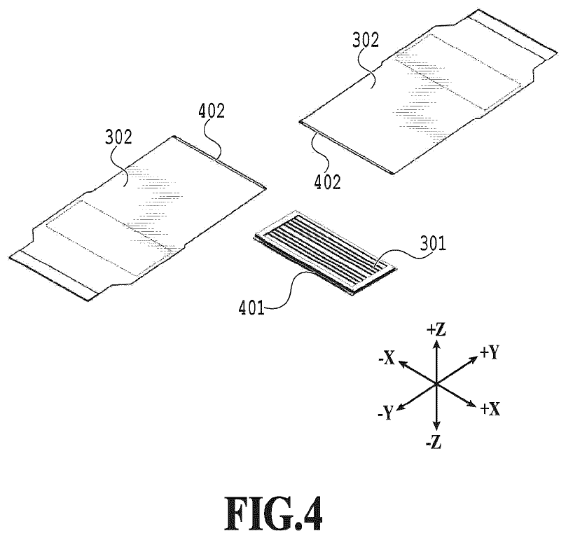

FIG. 4 is an exploded perspective diagram of the liquid ejection unit 202 in the present embodiment.

As shown in FIG. 4, at both end portions of the element substrate 301, a plurality of electrode terminals 401 is provided along the longitudinal direction. At the end portion of the electrical wiring substrate 302, an electrical connection section 402 is provided along the transverse direction. In the electrical connection section 402, a conductor (for example, wiring line including copper and nickel) is exposed in the shape of a pad and functions as a connection area with the electrode terminal 401. By the electrical connection section 402 coming into contact with the electrode terminal 401, the element substrate 301 and the electrical wiring substrate 302 are connected electrically.

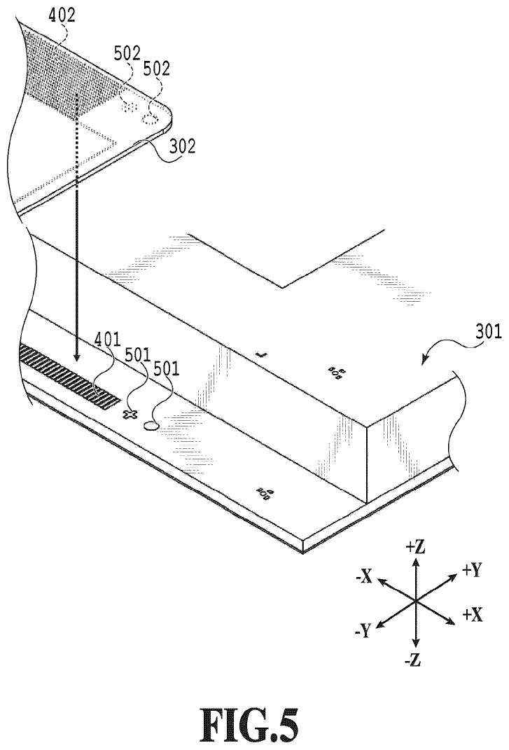

FIG. 5 is a diagram for explaining the configuration for connection between the element substrate 301 and the electrical wiring substrate 302 in the present embodiment.

As shown in FIG. 5, at both end portions of the element substrate 301, first alignment marks 501 are provided, which serve as a reference of registration in a case where the electrical wiring substrate 302 is connected. On the other hand, at the end portion of the electrical wiring substrate 302, second alignment marks 502 are provided, which serve as a reference of registration with the element substrate 301. By this registration, it is possible to perform registration of the electrical connection section 402 of the electrical wiring substrate 302 with the element substrate 301 with accuracy.

As described above, the element substrate 301 of the present embodiment includes a piezoelectric element as an energy generation element for ejecting liquid. There is a tendency for the element substrate 301 ejecting liquid by the piezoelectric method to be provided with a comparatively large number of electrode terminals 401. Because of this, in the present embodiment, the interval between two adjacent electrode terminals is comparatively narrow. In the situation such as this, in order to connect the electrical connection section 402 to the electrode terminal 401 accurately, it is preferable to perform highly accurate registration by aligning the first alignment marks 501 and the second alignment marks 502 with each other.

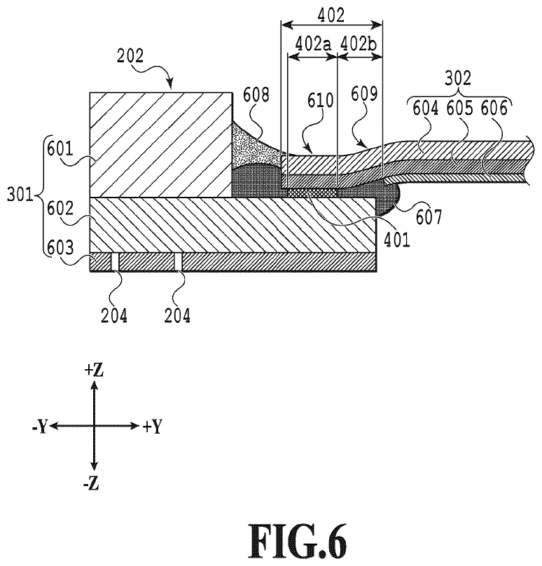

FIG. 6 is a cross-sectional diagram schematically showing the liquid ejection unit 202 in the present embodiment and mainly showing a positional relationship between the electrical connection section 402 of the electrical wiring substrate 302 and the electrode terminal 401 of the element substrate.

As shown in FIG. 6, the element substrate 301 comprises a channel forming substrate 601 having a channel (not shown schematically), an actuator substrate 602 having a surface on which the electrode terminal 401 is provided, and an ejection port forming substrate 603 in which the ejection port 204 is formed. On the ejection port forming substrate 603, the actuator substrate 602 is laminated and on the actuator substrate 602, the channel forming substrate 601 is laminated.

The electrical wiring substrate 302 comprises a base portion 604 including polyimide, a wiring portion 605 including copper and nickel, and a cover portion 606 including solder resist. The connection between the element substrate 301 and the electrical wiring substrate 302 is maintained by a non-conductive paste 607.

Onto the non-conductive paste 607, a sealing member 608 is applied. It is preferable for the sealing member 608 to have rigidity for protecting the connection between the element substrate 301 and the electrical wiring substrate 302 from an exterior force and to be capable of suppressing corrosion resulting from liquid for ejection, humidity in the environment, and the like. As one preferable example of the sealing member 608, there is an epoxy resin or the like. However, the example of the sealing member 608 is not limited to the epoxy resin. It is possible to include various materials in accordance with the required performance in the sealing member 608.

As shown in FIG. 6, the electrical connection section 402 of the electrical wiring substrate 302 has a connection range 402a connecting with the electrode terminal 401 and a non-connection range 402b adjacent to the connection range 402a and not opposite to the electrode terminal 401. Specifically, the connection range 402a is opposite to the range in which the electrode terminals 401 on the actuator substrate 602 of the element substrate 301 are arrayed and connected to these electrode terminals 401.

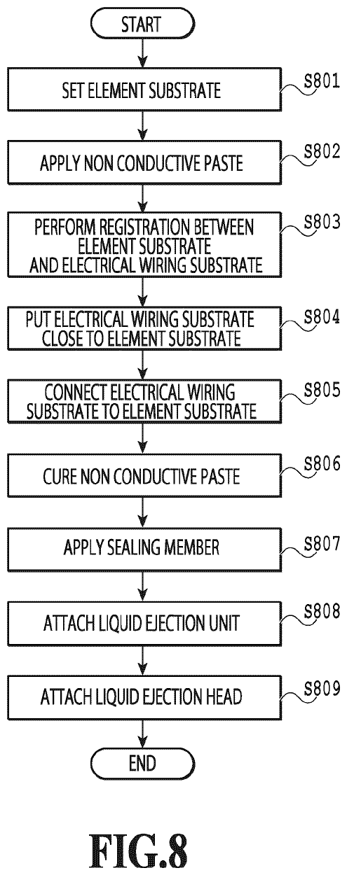

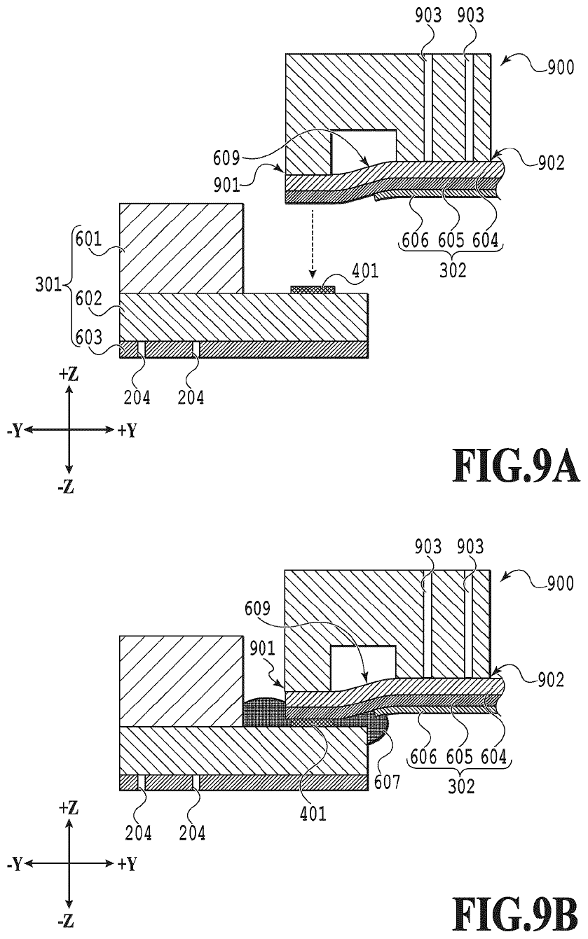

In the present embodiment, the non-connection range 402b of the electrical connection section 402 has an inclined portion 609 configured to incline in the direction (in the upward direction in FIG. 6) in which the inclined portion 609 becomes distant from the actuator substrate 602. This inclined portion 609 is formed by the inclination being formed in a manufacturing process to be described in FIG. 8, FIG. 9A, and FIG. 9B.

It is preferable for the angle of the inclined portion 609 to be 160 degrees or more with respect to a horizontal portion 610 of the electrical connection section 402 substantially parallel to the surface on which the electrode terminal 401 is provided. The reason is that the electrical wiring substrate 302 has an elastic restoring force and the elastic restoring force becomes great as the angle of the inclined portion 609 becomes small. That is, the reason is that it becomes difficult to form and maintain the inclined portion 609 by the above-described inclination formation in a case where the angle of the inclined portion 609 is too small.

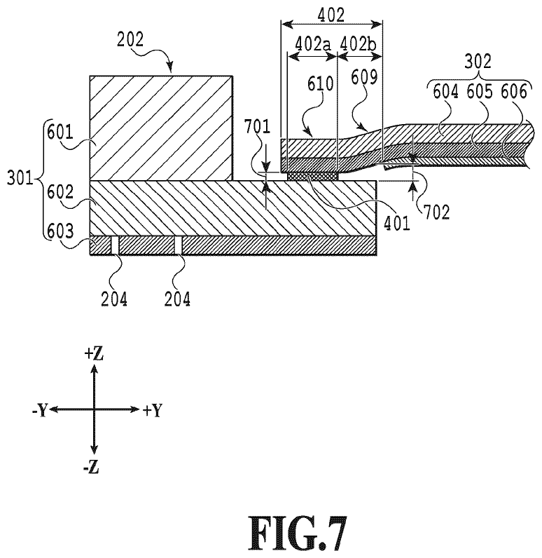

Further, as details will be described later in FIG. 7, the electrical connection section 402 is configured so that the distance between the highest point of the inclination of the non-connection range 402b and the actuator substrate 602 is greater than the distance between the connection range 402a and the actuator substrate 602.

By the wiring portion 605 being connected to the electrode terminal 401, it is made possible to supply energy and an electric signal for ejecting liquid from the electrical wiring substrate 302 to the element substrate 301. Then, it is made possible for the element substrate 301 to energize the outside by receiving current flowing from the outside, communicate with the outside by receiving an electric signal sent from the outside, and eject liquid via the electrical wiring substrate 302.

In the present embodiment, the actuator substrate 602 of the element substrate 301 comprises an energy generation element (piezoelectric element not shown schematically) including an upper electrode film (not shown schematically), a piezoelectric layer (not shown schematically), and a lower electrode film (not shown schematically). In a case of receiving a signal supplied from the wiring portion 605 via the electrode terminal 401, the actuator substrate 602 changes the volume of the piezoelectric element and ejects liquid droplets from the ejection port 204.

On the element substrate 301 adopting the piezoelectric method, the channels are divided individually into the number corresponding to the number of ejection ports 204 ejecting liquid droplets and to each individual channel, a piezoelectric element generating a pressure for ejection is attached. In a case where an attempt is made to form the ejection ports 204 in a high density without changing the dimensions and the like of the element substrate 301, it becomes necessary to increase the number of piezoelectric elements. Accompanying an increase in the number of piezoelectric elements, the number of necessary electrode terminals 401 also increases. In a case where the number of electrode terminals 401 increases, the number of electrodes increases accordingly.

As explained above, according to the connection configuration of the present embodiment, the non-connection range 402b adjacent to the connection range 402a of the electrical connection section 402 of the electrical wiring substrate 302 inclines with respect to the actuator substrate 602 of the element substrate 301 so that the non-connection range 402b becomes distant from the actuator substrate 602. Consequently, the non-connection range 402b is in the state of being distant from the actuator substrate 602 by the inclined portion 609 formed in advance even in a case where the electrical wiring substrate 302 inclines unintentionally while the wiring portion 605 is being put close to the actuator substrate 602. According to the connection method such as this, in the process of connecting the electrical wiring substrate 302 to the element substrate 301, it is possible to suppress the wiring portion 605 from coming into contact with the actuator substrate 602.

FIG. 7 is a diagram explaining a positional relationship in the connection between the element substrate 301 and the electrical wiring substrate 302 explained in FIG. 6. FIG. 7 shows a connection process in the liquid ejection head manufacturing process and in this stage, the non-conductive paste 607 and the sealing member 608 (see FIG. 6) shown in FIG. 6 are not formed.

As shown in FIG. 7, in the direction perpendicular to the surface on which the electrode terminal 401 is provided, a second distance between the end portion of the element substrate 301 and the electrical wiring substrate 302 is greater than a first distance between the surface on which the electrode terminal 401 is provided and the portion opposite to the electrode terminal 401.

Specifically, in the direction perpendicular to the surface on which the electrode terminal 401 is provided on the actuator substrate 602, a distance 702 from the edge of the surface to the non-connection range 402b is greater than a distance 701 from the surface to the connection range 402a.

Due to this, in the process of connecting the electrical wiring substrate 302 to the element substrate 301, for example, even in a case where the electrical wiring substrate 302 inclines unintentionally, it is possible to suppress the situation in which the wiring portion 605 comes into contact with the actuator substrate 602 and so on, which will be caused by the inclination.

Further, by keeping the connection range 402a of the electrical wiring substrate 302 linear and inclining the non-connection range 402b, it is possible to suppress an unintentional contact between the wiring portion 605 and the actuator substrate 602 described above or the like while appropriately securing the electrical connection.

It is possible for the liquid ejection unit 202 of the present embodiment, which is manufactured by the manufacturing method such as this, to suppress trouble (for example, current leakage, short circuit and the like) that occurs by the wiring portion 605 coming into contact with the actuator substrate 602.

### <Manufacturing Method of Liquid Ejection Apparatus 100>

FIG. 8 is a flowchart showing a manufacturing process of the liquid ejection apparatus 100 in the present embodiment. A symbol “S” in the explanation of each process means a step (process) in the flowchart.

At S801, the element substrate 301 (not shown schematically in FIG. 8) is set. After this process is completed, the process at S802 is performed.

At S802, the non-conductive paste 607 (not shown schematically in FIG. 8) is applied to the electrode terminal 401 (not shown schematically in FIG. 8) of the element substrate 301 and around the electrode terminal 401. After this process is completed, the process at S803 is performed.

Further, it may also be possible to perform hydrophilic treatment for the surface opposite to the element substrate 301 on the electrical wiring substrate 302 (not shown schematically in FIG. 8) before the time in point at which the electrical wiring substrate 302 is connected to the element substrate 301. On the surface for which the hydrophilic treatment has been performed, wettability improves and the non-conductive paste 607 becomes more likely to spread because of the improvement of wettability, and therefore, it is possible to suppress the non-conductive paste 607 from dropping and flowing into the ejection port 204 (not shown schematically in FIG. 8). It may also be possible to perform treatment other than hydrophilic treatment for the purpose of suppressing the non-conductive paste 607 from dropping. Further, the present disclosure is not limited to performing hydrophilic treatment for the electrical wiring substrate 302.

At S803, registration between the element substrate 301 and the electrical wiring substrate 302 is performed. Before the point in time at which this process is performed, the electrical wiring substrate 302 is held in the state of being sucked by an inclination forming tool 900 (see FIG. 9A), to be described later. After this process is completed, the process at S804 is performed.

At S804, the electrical wiring substrate 302 is put close to the element substrate 301. Specifically, the electrical wiring substrate 302 is put close to the surface on which the electrode terminal 401 of the element substrate 301 is provided with the state where the electrical wiring substrate 302 is substantially parallel to the surface being kept by the inclination forming tool 900. After this process is completed, the process at S805 is performed.

At S805, the electrical wiring substrate 302 is connected to the element substrate 301. Specifically, in the state where the connection range 402a of the electrical wiring substrate 302 is in contact with the electrode terminal 401 of the element substrate 301, by using the inclination forming tool 900 (see FIG. 9B), the connection range 402a is thermally compressed to the electrode terminal 401 from above the base portion 604. After this process is completed, the process at S806 is performed.

At S806, the non-conductive paste 607 is cured. Specifically, in accordance with the curing properties of the non-conductive paste 607 being in use, temperature and time are allowed for the non-conductive paste 607. Then, a force of shrinkage on curing appears and the non-conductive paste 607 cures. By the non-conductive paste 607 curing, the connection between the element substrate 301 and the electrical wiring substrate 302 is maintained. After this process is completed, the process at S807 is performed.

At S807, the sealing member 608 is applied onto the non-conductive paste 607. Through this process, the liquid ejection unit 202 is completed. After this process is completed, the process at S808 is performed.

At S808, the liquid ejection unit 202 is attached to the main body of the liquid ejection head 103 (not shown schematically in FIG. 8). Through this process, the liquid ejection head 103 is completed. After this process is completed, the process at S809 is performed.

At S809, the liquid ejection head 103 is attached to a predetermined position of the liquid ejection apparatus 100 (not shown in FIG. 8). Through this process, the liquid ejection apparatus 100 is completed.

The above is the explanation of the flowchart of the manufacturing process of the liquid ejection apparatus 100.

FIG. 9A is an explanatory diagram of a process of putting the electrical wiring substrate 302 close to the element substrate 301.

As shown in FIG. 9A, before the point in time at which the process of putting the electrical wiring substrate 302 close to the element substrate 301 is performed, the electrical wiring substrate 302 is held by the inclination forming tool 900. The inclination forming tool 900 has a pressure surface 901 capable of pressing and heating the electrical wiring substrate 302 and an adsorption surface 902 capable of adsorbing and holding the electrical wiring substrate 302. The adsorption surface 902 is provided with a suction unit 903 configured to suck in the electrical wiring substrate 302. The adsorption surface 902 is located above the pressure surface 901 in the vertical direction.

Consequently, in a case where the electrical wiring substrate 302 is sucked up by the suction unit 903 in a state where the electrical wiring substrate 302 is in contact with the pressure surface 901, part closer to the inside than the portion in contact with the pressure surface 901 comes into close contact with the adsorption surface 902. That is, in a case where the electrical wiring substrate 302 is sucked up in a state where the electrical wiring substrate 302 is in contact with the pressure surface 901, the electrical wiring substrate 302 deforms elastically and the inclined portion 609 is formed. However, in a case where the suction by the suction unit 903 stops, the electrical wiring substrate 302 returns to the original shape by the elastic restoring force.

FIG. 9B is an explanatory diagram of a process of connecting the electrical wiring substrate 302 to the element substrate 301.

As shown in FIG. 9B, before the point in time at which the process of connecting the electrical wiring substrate 302 to the element substrate 301, the non-conductive paste 607 is applied around the electrode terminal 401 on the actuator substrate 602. In a case where the non-conductive paste 607 is heated and time elapses in a state where the inclined portion 609 is formed by the inclination forming tool 900, the non-conductive paste 607 cures and the shape of the inclined portion 609 is maintained. That is, also after the point in time at which the inclination forming tool 900 is removed from the electrical wiring substrate 302, by the non-conductive paste 607 having cured, the electrical wiring substrate 302 is supported and the shape of the inclined portion 609 is maintained. The temperature and time necessary for curing the non-conductive paste 607 depend on the material included in the non-conductive paste 607.

### <Contact Between Actuator Substrate 602 and Electrical Connection Section 402>

In the following, the contact between the actuator substrate 602 and the electrical connection section 402 is explained by showing a comparative example. Explanation of the same configuration as that of the present embodiment is omitted appropriately and points different from those of the present embodiment are explained mainly.

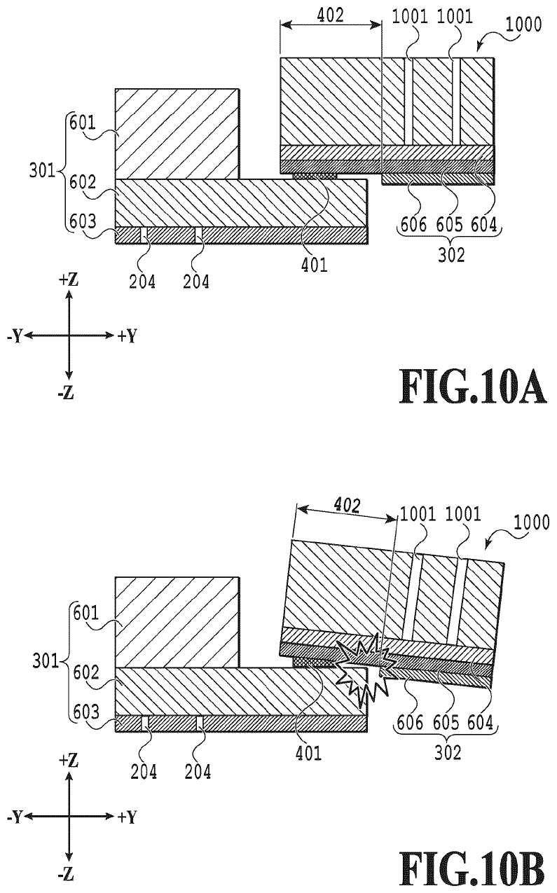

FIG. 10A is a diagram showing a state where the electrical wiring substrate 302 is connected correctly to the element substrate 301 in the comparative example.

As shown in FIG. 10A, in the comparative example, a bonding tool 1000 for connecting the electrical wiring substrate 302 to the element substrate 301 is used. The bonding tool 1000 was also used in the prior art. It is possible for the bonding tool 1000 to thermally compress the electrical connection section 402 of the electrical wiring substrate 302 to the electrode terminal 401 of the element substrate 301 and the bonding tool 1000 comprises a suction unit 1001 configured to such in the electrical wiring substrate 302. There is no difference in height on the bottom face of the bonding tool 1000 and the inclined portion 609 (see FIG. 6 and FIG. 7) is not formed even in a case where the electrical wiring substrate 302 is sucked in by the suction unit 1001.

Whether or not the inclined portion 609 is present, as long as it is possible to connect the electrical wiring substrate 302 to the element substrate 301 parallelly, the above-described trouble does not occur.

FIG. 10B is a diagram showing a state where the electrical wiring substrate 302 is not connected correctly to the element substrate 301 in the comparative example.

As shown in FIG. 10B, on the electrical wiring substrate 302 in the comparative example, the inclined portion 609 is not formed. Because of this, for example, in a case where the electrical wiring substrate 302 inclines in a state where the bonding tool 1000 holds the electrical wiring substrate 302, there is a possibility that the electrical connection section 402 comes into contact with the actuator substrate 602. That is, in this comparative example, there is a possibility that the above-described trouble occurs.

In contrast to this, in the present embodiment, on the electrical wiring substrate 302, the inclined portion 609 (see FIG. 6 and FIG. 7) is formed and a large clearance from the actuator substrate 602 to the wiring portion 605 is secured. Consequently, according to the technique of the present disclosure, for example, in a case where the electrical wiring substrate 302 inclines unintentionally in the process of connecting the electrical wiring substrate 302 to the element substrate 301, the electrical connection section 402 is suppressed from coming into contact with the actuator substrate 602.

Consequently, according to the liquid ejection head 103 of the present embodiment, it is possible to improve the reliability of the connection section between the element substrate 301 and the electrical wiring substrate 302.

### Second Embodiment

In the present embodiment, by providing a concave portion in the non-correction range, the clearance between the element substrate and the electrical wiring substrate is made large. In the following, differences from the above-described embodiment are explained mainly. To the same components as those of the above-described embodiment, the same reference symbols are attached and duplicated explanation of those components is omitted appropriately.

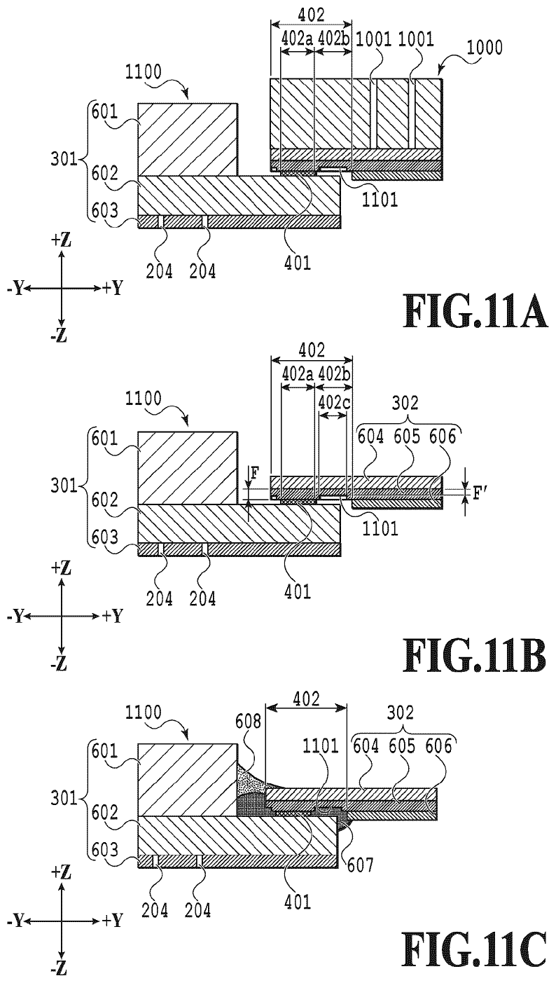

FIG. 11A is a schematic cross-sectional diagram showing the way a process of connecting the electrical wiring substrate 302 to the element substrate 301 is in the present embodiment.

As shown in FIG. 11A, in the non-connection range 402b of the present embodiment, a concave portion 1101 concave in the direction of becoming distant from the actuator substrate 602 is formed in a state where the electrical wiring substrate 302 is connected to the element substrate 301. In the state where the electrical wiring substrate 302 is connected to the element substrate 301, the concave portion 1101 is located above the edge of the actuator substrate 602 in the vertical direction.

Further, in the present embodiment, because the concave portion 1101 is formed, it is possible to make large the clearance between the element substrate 301 and the electrical wiring substrate 302 without the need to form an inclined portion. Because of this, it is possible to use the bonding tool 1000 that has been used in the prior art. According to the connection method such as this, it is not necessary to take into consideration the relationship between the elastic restoring force of the electrical wiring substrate 302 and the suction force of the suction unit 1001.

Consequently, according to the manufacturing method of the present embodiment, it is possible to thermally compress the connection range 402a to the electrode terminal 401 more easily than in the first embodiment.

FIG. 11B is a schematic cross-sectional diagram for explaining the concave portion 1101 in the present embodiment.

As shown in FIG. 11B, in the state where the electrical wiring substrate 302 is connected to the element substrate 301, a deepest portion 402c of the concave portion 1101 is located above the edge of the actuator substrate 602 in the vertical direction.

Further, in the electrical connection section 402 of the present embodiment, in a case where the thickness of the connection range 402a is taken to be “F” and the thickness from the adhesion surface with the base portion 604 to the deepest portion 402c of the concave portion 1101 is taken to be “F”, formula (1) below holds.

F>F′ Formula (1)

According to the configuration such as this, the distance from the edge of the actuator substrate 602 to the deepest portion 402c of the concave portion 1101 is greater than the distance from the surface on which the electrode terminal 401 of the actuator substrate 602 is provided to the undersurface of the connection range 402a.

Consequently, at the portion at which the concave portion 1101 is provided in the non-connection range 402b, it is possible to make the wiring portion 605 distant from the actuator substrate 602 by an amount corresponding to the depth in the concave portion 1101. That is, it is possible to reduce the possibility that the wiring portion 605 comes into contact with the actuator substrate 602 in the process of connecting the electrical wiring substrate 302 to the element substrate 301.

FIG. 11C is a schematic cross-sectional diagram of a second liquid ejection unit 1100 in the present embodiment.

As shown in FIG. 11C, by the non-conductive paste 607 flowing into the concave portion 1101, the element substrate 301 and the electrical wiring substrate 302 are connected more firmly than in the first embodiment. In a case where the above-described hydrophilic treatment is performed, it is preferable for the hydrophilic treatment to be performed also for the concave portion 1101. The reason is that the non-conductive paste 607 becomes more likely to flow into the concave portion 1101 compared to the case where the hydrophilic treatment is not performed.

Consequently, according to the second liquid ejection unit 1100, it is possible to improve reliability of the connection section between the element substrate 301 and the electrical wiring substrate 302. Further, it is also possible to connect the electrical wiring substrate 302 to the element substrate 301 more easily than in the first embodiment.

### Third Embodiment

In the present embodiment, by providing a step at the edge of the actuator substrate, the clearance between the element substrate and the electrical wiring substrate is made large. In the following, differences from the above described embodiments are explained mainly. To the same components as those of the above-described embodiments, the same reference symbols are attached and duplicated explanation of those components is omitted appropriately.

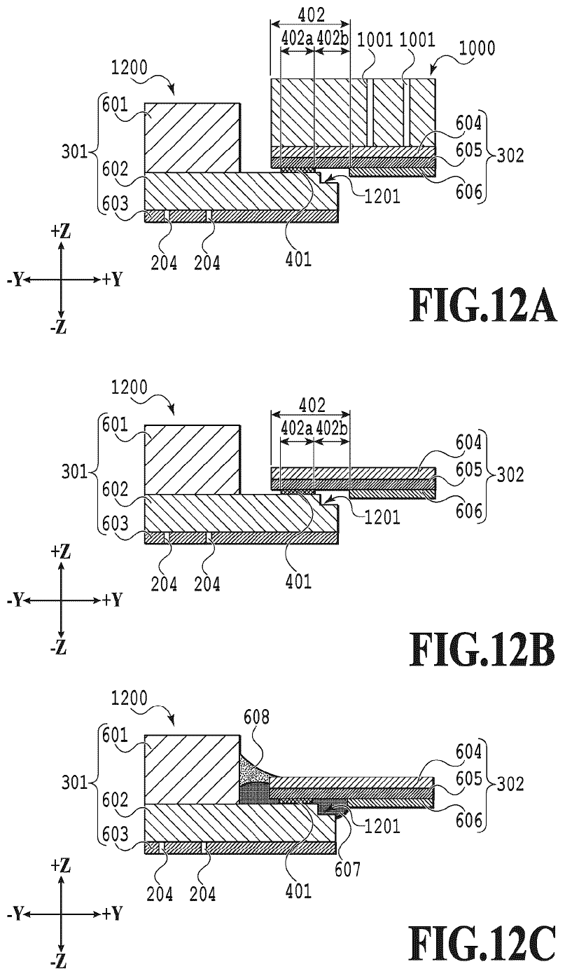

FIG. 12A is a schematic cross-sectional diagram showing the way a process of connecting the electrical connection section 402 to the electrode terminal 401 is in the present embodiment.

As shown in FIG. 12A, at the edge of the actuator substrate 602 of the present embodiment, in the state where the electrical wiring substrate 302 is connected to the element substrate 301, a step 1201 is formed, which goes down in the direction in which the step 1201 becomes more distant from the electrical connection section 402. In the state where the electrical wiring substrate 302 is connected to the element substrate 301, the step 1201 is located below the non-connection range 402b in the vertical direction.

FIG. 12B is a schematic cross-sectional diagram for explaining the step 1201 in the present embodiment.

As shown in FIG. 12B, in the present embodiment, the distance from the bottom portion of the step 1201 to the undersurface of the non-connection range 402b is greater than the distance from the surface on which the electrode terminal 401 on the actuator substrate 602 is provided to the undersurface of the connection range 402a. According to the configuration such as this, it is possible to make the actuator substrate 602 more distant from the electrical connection section 402 by an amount corresponding to the difference in height in the step 1201.

Consequently, in the process of connecting the electrical connection section 402 to the electrode terminal 401, it is possible to reduce the possibility that the wiring portion 605 comes into contact with the actuator substrate 602.

FIG. 12C is a schematic cross-sectional diagram of a third liquid ejection unit 1200 in the present embodiment.

As shown in FIG. 12C, by the non-conductive paste 607 staying on the step 1201, the element substrate 301 and the electrical wiring substrate 302 are connected more firmly than in the first embodiment. In a case where the above-described hydrophilic treatment is performed for the wiring portion 605, it is possible to suppress the non-conductive paste 607 from dropping from the step 1201 compared to the case where the hydrophilic treatment is not performed.

Consequently, according to the third liquid ejection unit 1200, it is possible to improve reliability of the connection section of the element substrate 301 and the electrical wiring substrate 302. Further, it is also possible to connect the electrical wiring substrate 302 to the element substrate 301 more easily than in the first embodiment.

### OTHER EMBODIMENTS

As above, the example to which the technique of the present disclosure can be applied is explained, but the technical scope of the present disclosure is not limited to the above-described example. The first, second, and third embodiments may be combined appropriately.

In the above-described embodiments, the manufacturing process of a liquid ejection apparatus is explained, but the order in which each process is performed is not limited as long as it is possible to manufacture a liquid ejection apparatus. The order of each process in the manufacturing process of a liquid ejection apparatus may be changed appropriately or the processes may be performed at the same time.

In the above-described embodiments, explanation is given by supposing the case where the liquid is ink, but the liquid to which the technique of the present disclosure can be applied is not limited to ink. That is, as the liquid, various printing liquids including a processing liquid and the like may be used, which are used for the purpose of improving the fixing property of ink in a printing medium, reducing gloss unevenness, and improving scratch resistance.

In the above-described embodiments, explanation is given by supposing the case where the printing medium is a cut sheet, but the printing medium is not limited to a cut sheet as long as it is possible to append liquid to the printing medium. As another example of the printing medium, there are continuous roll paper, plastic, film, fabric, metal, flexible substrate and the like.

In the above-described embodiments, the electrode terminals are provided along both sides of the element substrate, but the electrode terminals may be provided along all the sides of the element substrate. In this case, the electrical wiring substrate is pulled out of all the end portions on the element substrate. Consequently, compared to the above-described embodiments, it is possible increase the number of electrodes and increase the density of a plurality of formed ejection ports. By increasing the density of the ejection ports, it is made possible to maintain high printing quality also at the time of high-speed printing.

In the above-described embodiments, explanation is given by supposing the case where the energy generation unit is the piezoelectric element, but the example of the energy generation unit is not limited to the piezoelectric element as long as it is possible to append energy necessary for ejection to liquid. As another example of the energy generation element, there is an electrothermal converter. For example, it may also be possible to eject liquid from an election port by causing air bubbles to occur by giving heat to the liquid by using a heater as an electrothermal converter. It is also possible to apply the technique of the present disclosure to the so-called thermal liquid ejection unit such as this.

In the above-described embodiments, the so-called page-wide type liquid ejection head is used, but it is also possible to apply the technique of the present disclosure to a liquid ejection head performing printing while scanning. That is, it is also possible to apply the technique of the present disclosure to the so-called serial type liquid ejection head.

In the above-described embodiments, a plurality of liquid ejection units is arranged on one support member, but it is also possible to appropriately use the technique of the present disclosure for a liquid ejection head in which one liquid ejection unit is arranged on one support member.

In the above-described embodiments, the non-conductive paste is applied to the element substrate, but it may also be possible to connect an electrical wiring element to which the non-conductive paste is applied to an element substrate to which the non-conductive paste is not applied. That is, it is possible to appropriately select which of the element substrate and the electrical wiring substrate the non-conductive paste is applied to in accordance with the configuration of the liquid ejection apparatus.

In the above-described embodiments, the element substrate and the electrical wiring substrate are connected by the non-conductive paste, but the element substrate and the electrical wiring substrate may be connected by an anisotropic conductive film (ACF). Further, it is also possible to connect the element substrate and the electrical wiring substrate by a method, such as a metallic bonding method in which ultrasonic waves, heat and the like are used by using a metal bump formed on an electrode.

In the process of connecting the electrical wiring substrate to the element substrate in the first, second, and third embodiments, the electrical wiring substrate is put close to the element substrate in substantially the parallel (horizontal) state, where the distance between the element substrate and the electrical wiring substrate is made great. However, it is also possible to suppress an unintentional contact between the element substrate and the electrical wiring substrate by applying the technique of the present disclosure to the manufacturing method. That is, in a case where the electrical wiring substrate is put close to the element substrate in the connection process, it may also be possible to bring about the state where the more distant the electrical wiring substrate becomes from the electrode terminal by inclining the whole electrical wiring substrate, the greater the distance from the element substrate becomes. According to this manufacturing method, it is possible to suppress the contact between the element substrate and the electrical wiring substrate as in the above-described embodiments. Then, for example, it may also be possible to perform subsequent processes after returning the electrical wiring substrate to the normal state and connecting the electrode terminal of the element substrate and the electrical wiring substrate by causing a pressing force to act.

In the above-described embodiments, explanation is given by supposing the connection between the electrode terminal and the wiring line. However, the technique of the present disclosure is not limited to the connection between the electrode terminal and the wiring line and it is possible to widely apply the technique of the present disclosure to a technique to connect a terminal

According to the liquid ejection head of the present disclosure, it is possible to improve reliability of the connection section between an element substrate and an electrical wiring substrate.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-182414, filed Oct. 24, 2023, which is hereby incorporated by reference wherein in its entirety.

What is claimed is:

1. A liquid ejection head comprising:
an element substrate having a terminal; and
a wiring substrate including a wiring portion connected to the terminal in contact therewith and bonded to a first surface on which the terminal of the element substrate is provided, wherein
on the element substrate, a plurality of the terminals forms a terminal array arranged along an end portion of the element substrate and
in a direction perpendicular to the first surface on the element substrate, a second distance between the end portion of the element substrate and the wiring portion is greater than a first distance between the first surface and a portion opposite to the terminal of the wiring portion.

2. The liquid ejection head according to claim 1, wherein
the wiring substrate has an inclined portion inclining in a direction in which the inclined portion becomes distant from the first surface on the element substrate and
in a case of being viewed from a direction perpendicular to the first surface, the inclined portion overlaps the end portion of the element substrate.

3. The liquid ejection head according to claim 2, wherein
the angle of the inclined portion is 160 degrees or more with respect to the first surface.

4. The liquid ejection head according to claim 1, wherein
the wiring portion has a concave portion concave in a direction in which the concave portion becomes distant from the first surface on the element substrate.

5. The liquid ejection head according to claim 1, wherein
the element substrate has a step more distant from the wiring portion than the first surface.

6. The liquid ejection head according to claim 1, further comprising:
a non-conductive paste applied between the element substrate and the wiring portion, wherein
connection between the wiring portion and the terminal is maintained by the non-conductive paste.

7. The liquid ejection head according to claim 1, wherein
the element substrate has an ejection port ejecting liquid and an element generating energy for ejecting liquid from the ejection port.

8. The liquid ejection head according to claim 7, wherein
the element is a piezoelectric element.

9. A liquid ejection apparatus comprising:
a liquid ejection head;
an element substrate having a terminal; and
a wiring substrate including a wiring portion connected to the terminal in contact therewith and bonded to a first surface on which the terminal of the element substrate is provided, wherein
on the element substrate, a plurality of the terminals forms a terminal array arranged along an end portion of the element substrate and
in a direction perpendicular to the first surface on the element substrate, a second distance between the end portion of the element substrate and the wiring portion is greater than a first distance between the first surface and a portion opposite to the terminal of the wiring portion.

10. A manufacturing method of a liquid ejection head comprising an element substrate having a terminal and a wiring substrate including a wiring portion connected to the terminal in contact therewith and bonded to a first surface on which the terminal of the element substrate is provided, the manufacturing method comprising the step of:
connecting the terminal and the wiring portion, wherein
in the connecting, the terminal is connected to the wiring portion in a state where in a direction perpendicular to the first surface on the element substrate, a second distance between the end portion of the element substrate and the wiring portion is greater than a first distance between the first surface and a portion opposite to the terminal of the wiring portion.

11. The manufacturing method of a liquid ejection head according to claim 10, comprising the step of:
applying a non-conductive paste maintaining connection between the terminal and the wiring portion before the connecting.

12. The manufacturing method of a liquid ejection head according to claim 10, wherein
in the connecting, the terminal and the wiring portion are bonded by pressure bonding by a tool for holding the wiring substrate.

13. The manufacturing method of a liquid ejection head according to claim 12, wherein
the tool has a pressure surface pressing the wiring substrate and an adsorption surface located above the pressure surface in the vertical direction and adsorbing the wiring substrate and
in the connecting, by part of the wiring substrate being pressed by the pressure surface and by a portion of the wiring substrate, which is not pressed by the pressure surface, being sucked up by the adsorption surface, an inclined portion inclining so as to become distant from the terminal is formed on the wiring substrate.

14. The manufacturing method of a liquid ejection head according to claim 13, comprising the step of:
applying a non-conductive paste maintaining connection between the terminal and the wiring portion before the connecting, wherein
in the connecting, the non-conductive paste is cured and the shape of the inclined portion is maintained.
